(19) United States
(12) Patent Application Publication
(10) Pub. No.: US 2014/0347574 A1
(43) Pub. Date: Nov. 27, 2014

(54) METHOD OF PLASTIC TOUCH SENSOR PROCESS

(71) Applicant: Apple Inc., Cupertino, CA (US)

(72) Inventors: Chun-Hao TUNG, Luzhu Township (TW); Sunggu Kang, San Jose, CA (US); John Z. Zhong, Saratoga, CA (US)

(73) Assignee: Apple Inc., Cupertino, CA (US)

(21) Appl. No.: 13/899,391

(22) Filed: May 21, 2013

(51) Int. Cl. G06F 1/16

(52) U.S. Cl. CPC G06F 1/169
USPC 349/12; 264/400

(57) ABSTRACT

Methods of fabrication of a touch sensor panel using laser ablation are provided. The fabricated touch sensor panel can have touch sensors disposed on a surface of a substrate. A fabrication method can include depositing a first conductive layer onto a substrate in a touch sensor region and a border region, depositing a second conductive layer onto the first conductive layer in the border region, and ablating the second conductive layer at removal locations in the border region to define border traces for providing off-panel connections to touch sensors in the touch sensor region. This fabrication method can advantageously provide touch sensors in a fabrication process with high throughput using low cost material and equipment.

### FIELD OF THE DISCLOSURE

This relates generally to touch sensor panels and, more particularly, to fabrication of a touch sensor panel using laser ablation.

### BACKGROUND OF THE DISCLOSURE

Touch sensor panels are increasingly used as input devices to a computing system. Generally, a touch sensor panel can include a substrate (formed from glass, polymer, or the like) with touch sensors to sense proximity to the touch sensor panel.

### SUMMARY OF THE DISCLOSURE

This relates to fabrication of a touch sensor panel using laser ablation. The fabricated touch sensor panel can have touch sensors disposed on a surface of a substrate. A fabrication method can include depositing a first conductive layer onto a substrate in a touch sensor region and a border region, depositing a second conductive layer onto the first conductive layer in the border region, and ablating the second conductive layer at removal locations in the border region to define border traces for providing off-panel connections to touch sensors in the touch sensor region. This fabrication method can advantageously provide touch sensors in a fabrication process with high throughput using low cost material and equipment.

### BRIEF DESCRIPTION OF THE DRAWINGS

FIG. 1A illustrate a first side of an exemplary touch sensor panel fabricated using laser ablation according to examples of the disclosure.

FIG. 1B illustrate a second side of an exemplary touch sensor panel fabricated using laser ablation according to examples of the disclosure.

FIG. 2A illustrates a first transparent conductive layer deposited on a touch sensor panel substrate according to examples of the disclosure.

FIG. 2B illustrates a second conductive layer deposited on a first conductive layer according to examples of the disclosure.

FIG. 2C illustrates an exemplary touch sensor panel with a second conductive layer ablated at removal locations to form border traces according to examples of the disclosure.

FIG. 3 illustrates an exemplary method for fabricating a touch sensor panel using laser ablation according to examples of the disclosure.

FIG. 4 is a block diagram illustrating exemplary interactions between the touch screen and the other components of the device according to examples of the disclosure.

FIG. 5 is a block diagram illustrating an example of a system architecture that may be embodied within any portable or non-portable device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to fabrication of a touch sensor panel using laser ablation. The fabricated touch sensor panel can have touch sensors disposed on a surface of a substrate. A fabrication method can include depositing a first conductive layer onto a substrate in a touch sensor region and a border region, depositing a second conductive layer onto the first conductive layer in the border region, and ablating the second conductive layer at removal locations in the border region to define border traces for providing off-panel connections to touch sensors in the touch sensor region. This fabrication method can advantageously provide touch sensors in a fabrication process with high throughput using low cost material and equipment.

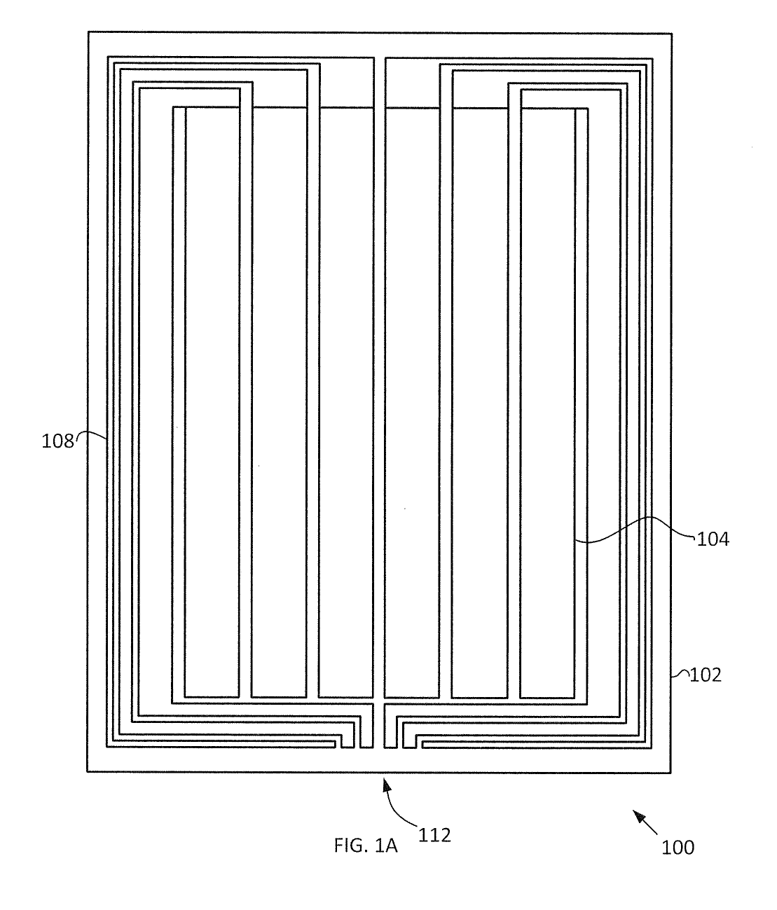

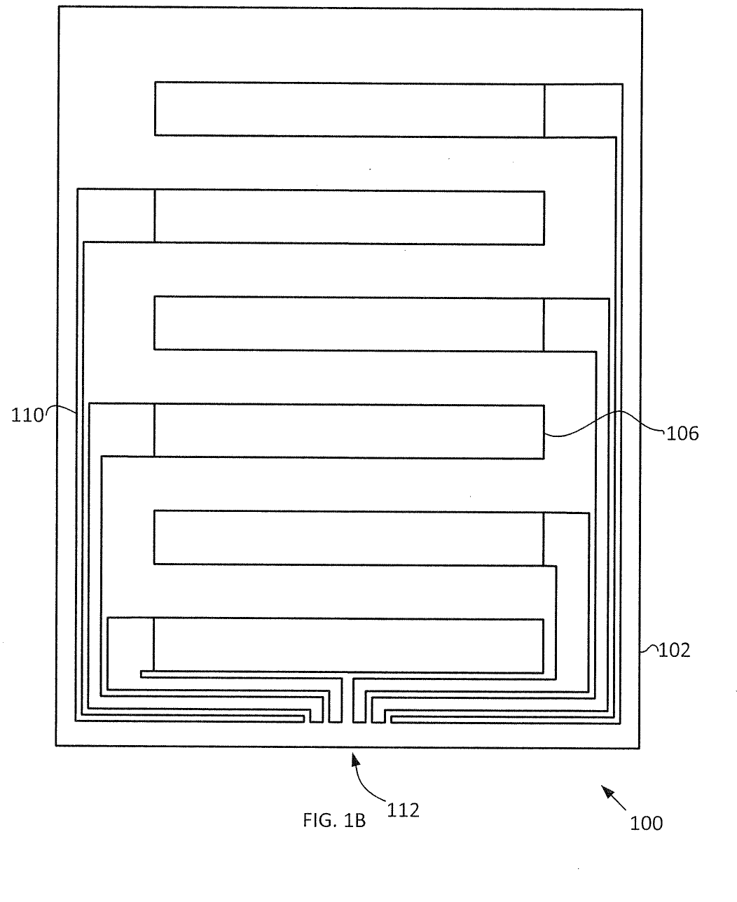

FIGS. 1A and 1B illustrate a first and second side, respectively, of an exemplary touch sensor panel fabricated using laser ablation according to various examples. In the examples of FIGS. 1A and 1B, touch sensor panel 100 can include substrate 102 having touch sensors 104 and 106 for sensing proximity of an object, such as a user's finger, a stylus, and the like. Column traces 104 and row traces 106 can form a touch sensor node at each region where a column trace crosses a row trace. Additionally, border traces 108 and 110 formed in a border region of the substrate can provide off-panel connections at edge 112 from touch sensors 104 and 106 to off-panel circuitry (not shown). The touch sensors 104 and 106 and border traces 108 and 110 can be formed on the substrate 102 using laser ablation and printing, such as ink-jet printing or screen printing, for example, which will be described in more detail below. Laser ablation can fabricate touch sensors panels with high throughput using low cost material and equipment, especially compared to photolithography and etching, for example.

Although FIGS. 1A and 1B illustrate column and row traces on opposite sides of a substrate, some examples include column and row traces formed on a single side of a substrate. Additionally, the touch sensors are not limited to a row-column arrangement illustrated here, but can include radial, circular, diamond, and other arrangements capable of sensing a touch. Additionally, the border traces need not be routed to edge 112. In some examples, a first set of border traces may be routed to a first edge and a second set of border traces may be routed to a second edge. Additionally, FIG. 1A illustrates border traces routing from the edge opposite edge 112 to edge 112, but examples of the disclosure could include border traces that route from the edge opposite edge 112 to any edge of the substrate, including the edge opposite edge 112. Similarly, FIG. 1B illustrates border traces that fan out in opposite directions on alternate rows, but examples of the disclosure are not so limited and could include border traces in any number of configurations, routing to any edge of the substrate.

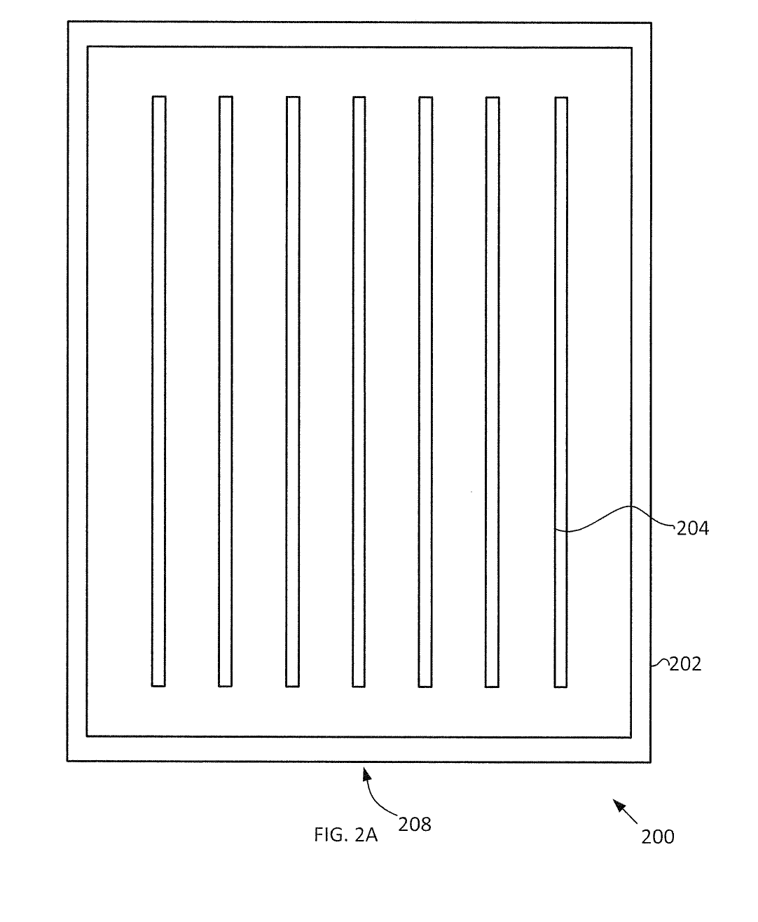

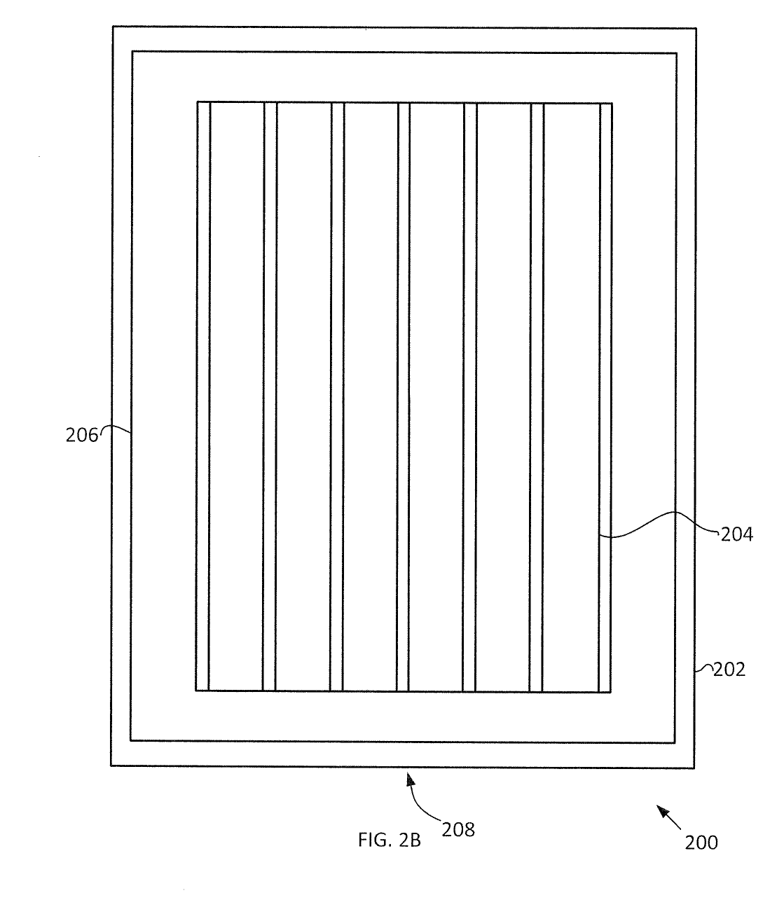

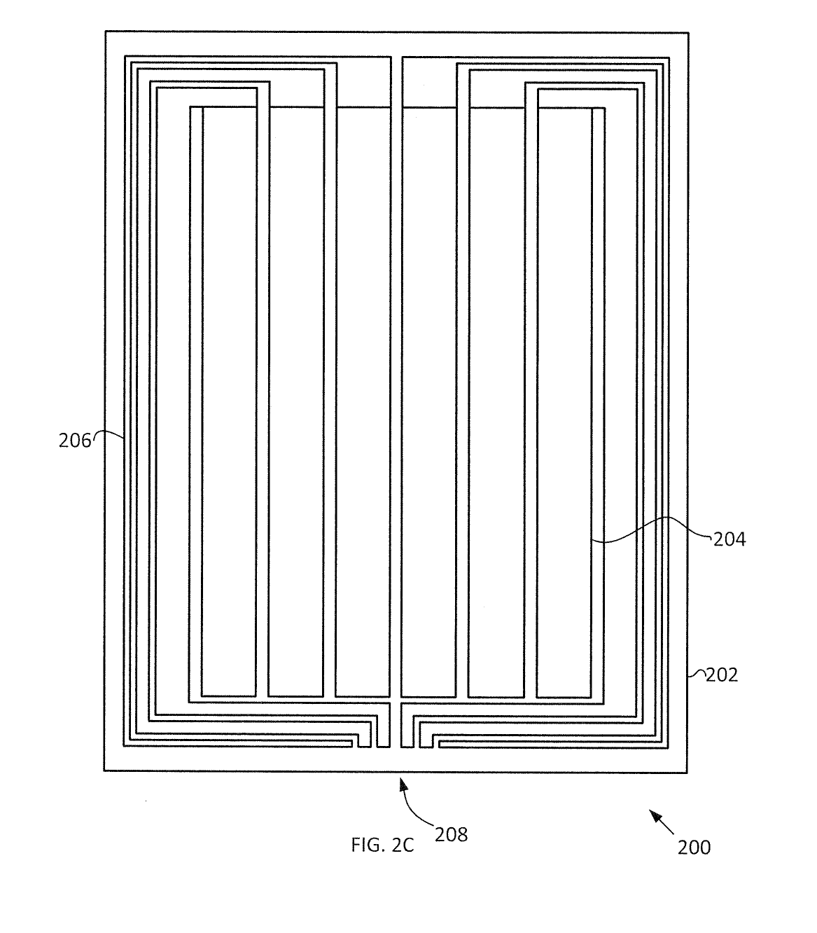

FIGS. 2A-2C illustrate the fabrication of an exemplary touch sensor panel according to examples of the disclosure. In the example of FIG. 2A, touch sensor panel 200 can include substrate 202 having transparent conductive layer 204 deposited on its surface. This first conductive layer can be patterned using any of sputtering, screen printing, laser ablation, photolithography, and/or etching, among other possibilities. The conductive layer can be indium-tin-oxide (ITO), indium-zinc-oxide (IZO), carbon nanotube (CNT), silver nanowire, PEDOT, or some other suitable conductive material, for example. In some examples, the transparent conductive layer may be patterned in a touch sensor region of the substrate such that gaps are formed between columns or rows, as illustrated in FIG. 2A.

In some examples, traces of the transparent conductive layer may be formed such that they are electrically isolated. Although FIG. 2A illustrates the transparent conductive layer 204 having column traces that are electrically connected in a border region, the patterning of this layer could remove the conductive material from the border region in this process step. In some examples, the transparent conductive layer may be formed such that the traces will only become electrically isolated later in the process during laser ablation. For example, FIG. 2A illustrates a transparent conductive layer 204 having column traces that are electrically connected in a border region. The transparent conductive layer 204 may be ablated in the border region later in the process to electrically isolate the column traces from each other.

In the example of FIG. 2B, a second conductive layer 206 can be deposited in the border region of the substrate 202 onto the transparent conductive layer 204. The second conductive layer can be patterned by screen printing or other suitable printing techniques. The second conductive layer can be copper, copper alloy, silver, or some other suitable conductive material, for example. The second conductive layer can then be ablated to form border traces, one for each column or row trace, to connect at edge 208 each touch sensor trace to off-panel circuitry (not shown). FIG. 2C illustrates an exemplary touch sensor panel 200 with the second conductive layer 206 ablated at removal locations to form border traces. A laser can remove the first and second conductive layer at removal locations to create gaps separating and electrically isolating the border traces from each other in the border region.

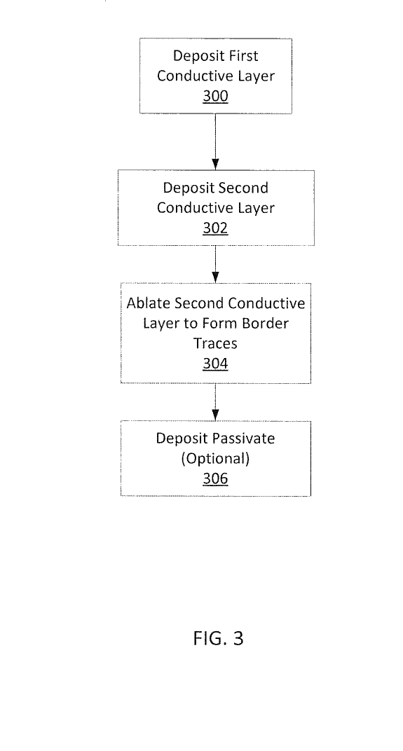

FIG. 3 illustrates an exemplary method for fabricating a touch sensor panel using laser ablation according to various examples. In the example of FIG. 3, a first conductive layer can be deposited on a surface of a substrate (300). The first conductive layer may be transparent, for example if the touch sensor panel is to be coupled with a display for use as a touch screen. The first conductive layer may include conductive material in a touch sensor region and conductive material in a border region. Additionally or alternatively, the conductive material in the touch sensor region may be patterned to form row and/or column traces, for example. Additionally or alternatively, the layer may be patterned to remove conductive material from the border region so as to electrically isolate each of the traces in the touch sensor region.

A second conductive layer can be deposited onto the first conductive layer in the border region (302). The second conductive layer may be ablated at removal locations in the border region to define border traces for providing off-panel connections to touch sensors in the touch sensor region (304). Additionally, the first conductive layer may be ablated at the removal locations in the border region concurrently with the ablation of the second conductive layer. The laser can remove some of the first and second conductive layers to form gaps that electrically isolate the border traces in the border regions. In some examples, the ablation may further form gaps to electrically isolate the touch sensors from each other.

Each step in the method illustrated in FIG. 3 may be performed concurrently on two sides of a substrate to form a double-sided touch sensor panel as illustrated in FIGS. 1A and 1B. For example, a conductive layer may be deposited on a first surface of a substrate concurrently with the deposition of a corresponding conductive layer on a second surface of a substrate. Additionally, conductive layers may be ablated on each side concurrently to form border traces.

In some examples, a passivation layer can optionally be deposited to cover some or all of the components on the substrate, including the touch sensors and the border traces (306). The passivation layer may not cover the border traces at an edge of the substrate so that the border traces can connect to off-panel circuitry, such as a flex circuit, for example. The passivation layer can protect the substrate components from corrosion or mechanical damage.

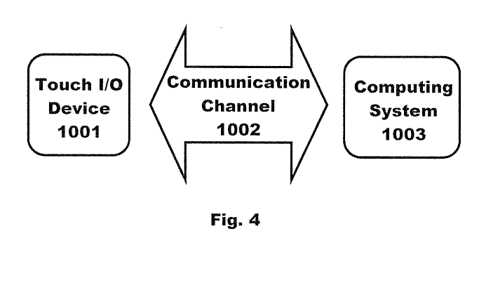

FIG. 4 is a block diagram illustrating exemplary interactions between the touch sensitive panel and the other components of the device. Described examples may include fabrication of some or all of touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensing panel as fabricated in the method of FIG. 3, which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensing surface for receiving touch input.

In one example, touch I/O device 1001 embodied as a touch screen may include a transparent and/or semitransparent touch sensing panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensing components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

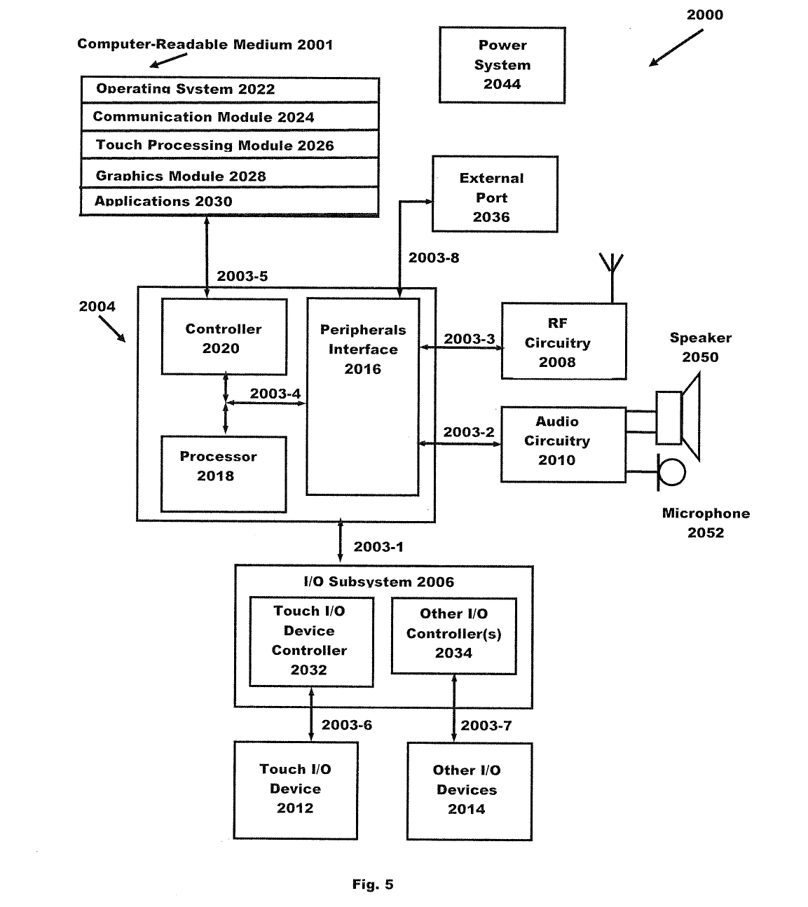

Attention is now directed towards examples of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 5 is a block diagram of one example of system 2000 that generally includes one or more computer-readable mediums 2001, processing system 2004, I/O subsystem 2006, radio frequency (RF) circuitry 2008, audio circuitry 2010, and gaze detection circuitry 2011. These components may be coupled by one or more communication buses or signal lines 2003.

It should be apparent that the architecture shown in FIG. 5 is only one example architecture of system 2000, and that system 2000 could have more or fewer components than shown, or a different configuration of components. The various components shown in FIG. 5 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some examples, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some examples, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various examples. In some examples, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In examples in which touch I/O device 2012 is a touch sensing display (e.g., touch screen), graphics module 2028 includes components for rendering, displaying, and animating objects on the touch sensing display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch sensing surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensing surface described in the following U.S. Pat. Nos.: 6,323,846 (Westerman et al.), 6,570,557 (Westerman et al.), and/or 6,677,932 (Westerman), and/or U.S. Patent Publication 2002/0015024A1, each of which is hereby incorporated by reference.

Examples in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some examples, peripherals interface 2016, one or more processors 2018, and memory controller 2020 may be implemented on a single chip, such as processing system 2004. In some other examples, they may be implemented on separate chips.

Examples of the disclosure can be advantageous in providing touch sensors in a fabrication process with high throughput using low cost material and equipment.

In some examples, a method is disclosed. The method may include depositing a first conductive layer onto a substrate in a touch sensor region and a border region; depositing a second conductive layer onto the first conductive layer in the border region; and concurrently ablating the second conductive layer and the first conductive layer at removal locations in the border region to define border traces for providing off-panel connections to touch sensors in the touch sensor region. Additionally or alternatively to one or more of the examples described above, the first conductive layer may be deposited on a first side of the substrate and the method may further include depositing a third conductive layer on a second side of the substrate in the touch sensor region and the border region concurrently with the depositing of the first conductive layer; depositing a fourth conductive layer onto the third conductive layer in the border region concurrently with the depositing of the second conductive layer; and concurrently ablating the third conductive layer and the fourth conductive layer at removal locations in the border region to define border traces for providing off-panel connections to touch sensors in the touch sensor region, wherein the ablation of the third and fourth conductive layers may be concurrent with the ablation of the first and second conductive layers. Additionally or alternatively to one or more of the examples described above, the first conductive layer may be transparent. Additionally or alternatively to one or more of the examples described above, the first conductive layer may be made of a first conductive material and the second conductive layer may be made of a second conductive material, different from the first conductive material. Additionally or alternatively to one or more of the examples described above, ablating the second conductive layer and first conductive layer may include removing portions of the layers to form gaps between the border traces. Additionally or alternatively to one or more of the examples described above, depositing a first conductive layer may include forming touch sensors in the touch sensor region that are electrically connected in the border region, and ablating the second conductive layer and first conductive layer may include forming gaps such that the touch sensors are electrically isolated from each other. Additionally or alternatively to one or more of the examples described above, the touch sensors may be capable of sensing proximity to the touch sensors. Additionally or alternatively to one or more of the examples described above, the method may further include depositing a passivation layer on one or both of the first conductive layer and the second conductive layer. Additionally or alternatively to one or more of the examples described above, the first conductive layer may include the touch sensors.

In some examples, a touch sensor panel is disclosed. The touch sensor panel may include a substrate; multiple touch sensors formed on the substrate in a touch sensor region by depositing a first conductive layer onto the substrate in the touch sensor region and a border region and ablating the first conductive layer at removal locations in the border region; and multiple border traces formed on the substrate in the border region by depositing a second conductive layer onto the first conductive layer in the border region and ablating the second conductive layer at the removal locations in the border region. Additionally or alternatively to one or more of the examples described above, the border traces may provide off-panel connections to the touch sensors in the touch sensor region. Additionally or alternatively to one or more of the examples described above, the ablating of the first conductive layer may be concurrent with the ablating of the second conductive layer. Additionally or alternatively to one or more of the examples described above, the first conductive layer may be deposited on a first side of the substrate; the touch sensors may be further formed by depositing a third conductive layer on a second side of the substrate in the touch sensor region and the border region concurrently with the depositing of the first conductive layer, and by ablating the third conductive layer at removal locations in the border region concurrently with the ablating of the first conductive layer; and the border traces may be further formed by depositing a fourth conductive layer on the third conductive layer in the border region concurrently with the depositing of the second conductive layer, and by ablating the fourth conductive layer at the removal locations in the border region concurrently with the ablating of the second conductive layer. Additionally or alternatively to one or more of the examples described above, the first conductive layer may be transparent. Additionally or alternatively to one or more of the examples described above, the first conductive layer may be made of a first conductive material and the second conductive layer may be made of a second conductive material, different from the first conductive material. Additionally or alternatively to one or more of the examples described above, ablating the second conductive layer and first conductive layer may include removing portions of the layers to form gaps between the border traces. Additionally or alternatively to one or more of the examples described above, depositing a first conductive layer may include forming touch sensors in the touch sensor region that are electrically connected in the border region, and ablating the second conductive layer and first conductive layer may include forming gaps such that the touch sensors are electrically isolated from each other. Additionally or alternatively to one or more of the examples described above, the touch sensors may be capable of sensing proximity to the touch sensors. Additionally or alternatively to one or more of the examples described above, the touch sensor panel may further include a passivation layer deposited on one or both of the first conductive layer and the second conductive layer. Additionally or alternatively to one or more of the examples described above, the first conductive layer may include the touch sensors.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method comprising:
depositing a first conductive layer onto a substrate in a touch sensor region and a border region;
depositing a second conductive layer onto the first conductive layer in the border region; and
concurrently ablating the second conductive layer and the first conductive layer at removal locations in the border region to define border traces for providing off-panel connections to touch sensors in the touch sensor region.

2. The method of claim 1, wherein the first conductive layer is deposited on a first side of the substrate, the method further comprising:
depositing a third conductive layer on a second side of the substrate in the touch sensor region and the border region concurrently with the depositing of the first conductive layer;
depositing a fourth conductive layer onto the third conductive layer in the border region concurrently with the depositing of the second conductive layer; and
concurrently ablating the third conductive layer and the fourth conductive layer at removal locations in the border region to define border traces for providing off-panel connections to touch sensors in the touch sensor region, wherein the ablation of the third and fourth conductive layers is concurrent with the ablation of the first and second conductive layers.

3. The method of claim 1, wherein the first conductive layer is transparent.

4. The method of claim 1, wherein the first conductive layer is made of a first conductive material and the second conductive layer is made of a second conductive material, different from the first conductive material.

5. The method of claim 1, wherein ablating the second conductive layer and first conductive layer includes removing portions of the layers to form gaps between the border traces.

6. The method of claim 1, wherein depositing a first conductive layer includes forming touch sensors in the touch sensor region that are electrically connected in the border region, and ablating the second conductive layer and first conductive layer includes forming gaps such that the touch sensors are electrically isolated from each other.

7. The method of claim 1, wherein the touch sensors are capable of sensing proximity to the touch sensors.

8. The method of claim 1, further comprising depositing a passivation layer on one or both of the first conductive layer and the second conductive layer.

9. The method of claim 1, wherein the first conductive layer includes the touch sensors.

10. A touch sensor panel comprising:
a substrate;
multiple touch sensors formed on the substrate in a touch sensor region by depositing a first conductive layer onto the substrate in the touch sensor region and a border region and ablating the first conductive layer at removal locations in the border region; and
multiple border traces formed on the substrate in the border region by depositing a second conductive layer onto the first conductive layer in the border region and ablating the second conductive layer at the removal locations in the border region.

11. The touch sensor panel of claim 10, wherein the border traces provide off-panel connections to the touch sensors in the touch sensor region.

12. The touch sensor panel of claim 10, wherein the ablating of the first conductive layer is concurrent with the ablating of the second conductive layer.

13. The touch sensor panel of claim 10, wherein the first conductive layer is deposited on a first side of the substrate;
wherein the touch sensors are further formed by depositing a third conductive layer on a second side of the substrate in the touch sensor region and the border region concurrently with the depositing of the first conductive layer, and by ablating the third conductive layer at removal locations in the border region concurrently with the ablating of the first conductive layer; and
wherein the border traces are further formed by depositing a fourth conductive layer on the third conductive layer in the border region concurrently with the depositing of the second conductive layer, and by ablating the fourth conductive layer at the removal locations in the border region concurrently with the ablating of the second conductive layer.

14. The touch sensor panel of claim 10, wherein the first conductive layer is transparent.

15. The touch sensor panel of claim 10, wherein the first conductive layer is made of a first conductive material and the second conductive layer is made of a second conductive material, different from the first conductive material.

16. The touch sensor panel of claim 10, wherein ablating the second conductive layer and first conductive layer includes removing portions of the layers to form gaps between the border traces.

17. The touch sensor panel of claim 10, wherein depositing a first conductive layer includes forming touch sensors in the touch sensor region that are electrically connected in the border region, and ablating the second conductive layer and first conductive layer includes forming gaps such that the touch sensors are electrically isolated from each other.

18. The touch sensor panel of claim 10, wherein the touch sensors are capable of sensing proximity to the touch sensors.

19. The touch sensor panel of claim 10, further comprising a passivation layer deposited on one or both of the first conductive layer and the second conductive layer.

20. The touch sensor panel of claim 10, wherein the first conductive layer includes the touch sensors.
